(19) United States
(12) Patent Application Publication
(10) Pub. No.: US 2016/0065375 A1
(43) Pub. Date: Mar. 3, 2016

(54) DYNAMIC INTEGRITY VALIDATION OF A HIGH LEVEL OPERATING SYSTEM

(71) Applicant: QUALCOMM Incorporated, San Diego, CA (US)

(72) Inventors: Yoni KAHANA, Bet Yehusha (IL); Erez TSIDON, Moreshet (IL); Elad LEVI, Acco (IL)

(21) Appl. No.: 14/472,207

(22) Filed: Aug. 28, 2014

(51) Int. Cl. H04L 9/32; G06F 9/44

(52) U.S. Cl. CPC H04L 9/3247; G06F 9/4406; H04L 2209/24; H04L 2209/72

(57) ABSTRACT

Techniques for dynamically validating the integrity of a High Level Operating System (HLOS) stored on a data processing device are provided. The techniques include a method for execution on a data processing device including initiating a boot sequence on the data processing device, reading a code partition from a memory unit in the data processing device, such that the code partition is associated with a HLOS stored in the memory unit, performing a cryptographic function on the code partition, storing a result of the cryptographic function in a secure memory, continuing the boot sequence to load at least a portion of the HLOS into a non-secure memory unit, cryptographically signing the result of the cryptographic function stored in the secure memory unit, and sending the encrypted result of the cryptographic function to a remote server.

### BACKGROUND

An aspect of this invention generally relates to data processing devices and more particularly to performing integrity checks on the High Level Operating System (HLOS) within a data processing device.

The security of an operating system within a data processing device is an increasingly important concern. A corrupted HLOS may allow malicious code (e.g., malware) to execute on a data processing device (e.g., smart phone, personal computer, tablet computer). Such malicious code may provide unauthorized access to a user's personal or confidential information, and/or commandeer the processing resources of the device for other nefarious uses such as spamming or coordinated denial of service attacks. A corrupted HLOS may also render the data processing device completely or partially inoperable. Examples of existing methods for validating an operating system include secure boot algorithms and external validation. A secure boot algorithm generally includes sequentially validating previously stored cryptographic data (e.g., hash tags) as the individual elements of the boot process execute. A failure to validate the hash code associated with a boot element interrupts the boot sequence and prevents the HLOS from loading. As a result, the device may not execute some or all of the operations with the HLOS. An external validation system may validate the integrity of the stored HLOS against one or more previously stored cryptographic functions (e.g., hash values). Such secure boot algorithms, however, are generally static since they may not be updated after the data processing device is manufactured. Further, external validation system may require an additional memory capacity to store such factory preset cryptographic functions.

The introduction of malicious code into the HLOS of a data processing device may create complications in the measurement and validation processes. A corrupt HLOS may interfere with the testing and measurement functions of the HLOS. A tampered HLOS may, for example, generate a false message or other measurement value as an input to a cryptographic function in an effort to generate a valid cryptographic result (e.g., hash tag). During validation, a corrupt HLOS may provide a previously generated hash tag rather than a hash that was obtained based on a current measurement. Thus the validation process may return a false positive result.

### SUMMARY

An example method for validating integrity of a High Level Operating System (HLOS) stored on a data processing device according to the disclosure includes initiating a boot sequence on the data processing device, reading a code partition from a memory unit in the data processing device, such that the code partition is associated with a HLOS stored in the memory unit, performing a cryptographic function on the code partition, storing a result of the cryptographic function in a secure memory unit, continuing the boot sequence to load at least a portion of the HLOS into a non-secure memory unit, signing the result of the cryptographic function stored in the secure memory unit, and sending the signed result of the cryptographic function to a remote server.

Implementations of such a method may include one or more of the following features. The code partition may be selected from the group consisting of a kernel partition, a system partition, and a recovery partition. The result of the cryptographic function may be a hash based on the code partition. The result of the cryptographic function may include executing a private key signing sequence of the hash. A notification message may be received from the remote server. The notification message may include a code segment configured to disable a process executing on the data processing device. The method may include receiving one or more hashes from one or more data processing devices, determining data cluster information based on the one or more hashes, and storing the data cluster information on the remote server. The method may also include receiving a first hash from a first data processing device, determining a distance value between the first hash and the data cluster information, and validating the integrity of the HLOS on the first data processing device based on the distance value.

An example of a non-transitory processor-readable storage medium comprising instructions for validating integrity of a High Level Operating System (HLOS) stored on a data processing device according to the disclosure includes code for initiating a boot sequence on the data processing device, code for reading a code partition from a memory unit in the data processing device, such that the code partition is associated with a HLOS stored in the memory unit, code for performing a cryptographic function on the code partition, code for storing a result of the cryptographic function in a secure memory unit, code for continuing the boot sequence to load at least a portion of the HLOS into a non-secure memory unit, code for performing a cryptographic signing on the result of the cryptographic function stored in the secure memory unit, and code for sending the signed result of the cryptographic function to a remote server.

Implementations of such a non-transitory processor-readable storage medium may include one or more of the following features. The code partition may be selected from the group consisting of a kernel partition, a system partition, and a recovery partition. The medium may include code for generating a hash based on the code partition as the result of the cryptographic function. Code for executing a private key signing sequence of the hash. Code for receiving a notification message from the remote server. Code for disabling a process executing on the data processing device. Code for receiving the one or more hashes from one or more data processing devices, code for determining data cluster information based on the one or more hashes, and code for storing the data cluster information on the remote server. Code for receiving a first hash from a first data processing device, code for determining a distance value between the first hash and the data cluster information, and code for validating the integrity of the HLOS on the first data processing device based on the distance value.

An apparatus according to the disclosure includes a first memory unit for storing instructions, and a first processor unit coupled to the first memory unit and configured to initiate a boot sequence on the data processing device, read a code partition from the first memory unit in the data processing device, such that the code partition is associated with a HLOS stored in the first memory unit, perform a cryptographic function on the code partition, store a result of the cryptographic function in a secure memory unit, continue the boot sequence to load at least a portion of the HLOS into the first memory unit, sign the result of the cryptographic function stored in the secure memory unit, and send the signed result of the cryptographic function to a remote server.

Implementations of such an apparatus may include one or more of the following features. The result of the cryptographic function may be a hash based on the code partition, and encrypting the result of the cryptographic function may include executing a private key signing sequence of the hash. The apparatus my include a second apparatus including a second memory unit for storing instructions, and a second processor unit coupled to the second memory unit configured to receive one or more hashes from one or more data processing devices, determine data cluster information based on the one or more hashes, and store the data cluster information. The second processor unit may be further configured to receive a first hash from a first data processing device, determine a distance value between the result of cryptographic function and the data cluster information, and validate the integrity of the HLOS on the first data processing device based on the distance value.

Items and/or techniques described herein may provide one or more of the following capabilities and/or possibly one or more other capabilities not mentioned. The integrity of a HLOS on a data processing device may be validated. A boot application may calculate a cryptographic function (e.g., hash) on partitions the HLOS that are stored on an Embedded Multi-Media Card (eMMC) or other memory device. The hash calculations may be performed on the Kernel (boot), system, and/or recovery partitions. Hash results on other partitions or program elements may also be used. The hash results may be transferred to a trusted memory location (e.g., an ARM TrustZone®). The trusted memory is configured to store the hash results calculated and transferred during the boot sequence. The HLOS may be loaded into working memory after the hash results are stored in the trusted memory. A TrustZone application may utilize the loaded HLOS to read the hash results from the trusted memory. The TrustZone application may utilize a key to sign (i.e., encrypt) the hash results. The signed hash results may be transferred to a networked server (i.e., the cloud, a trusted web service). The server may be configured to verify the integrity of the hash results. Clusters of hash results on the database may be realized. The hash results may be compared to the database to help determine if the HLOS has been tampered with. Clusters associated with specific malware may be determined. The HLOS may be updated on the device, and the database may be updated with the expected hash results to validate integrity of the HLOS installed on the device. Further, it may be possible for an effect noted above to be achieved by means other than they noted and a noted item/technique may not necessarily yield the noted effect.

### BRIEF DESCRIPTION OF THE DRAWINGS

FIG. 1 is a functional block diagram of an example networked computer system in which the HLOS validation techniques discussed herein may be implemented.

FIG. 2 is a functional block diagram of the example computer system utilizing a HLOS.

FIG. 3 is an exemplary sequence diagram of a HLOS validation process.

FIG. 4 is an exemplary sequence diagram of a HLOS validation process including multiple cryptographic functions for HLOS partitions.

FIG. 5 is a flow diagram of a process for providing HLOS validation information to a remote server.

FIG. 6A is a flow diagram of a process for determining HLOS validation information clusters.

FIG. 6B is a flow diagram of a process for dynamically verifying HLOS validation information.

### DETAILED DESCRIPTION

Techniques disclosed herein are configured to validate the integrity of a HLOS on a data processing device. In modern personal data processing devices such as mobile phones, PCs or tablets there is a need to perform integrity check on the High Level Operating System (HLOS). An object of an integrity validation process is to determine whether the HLOS has been compromised or tampered with. An HLOS integrity validation process should be configured to provide trusted validation results even if the HLOS executing on the device has been tampered with. Preferably, an HLOS integrity validation process should not involve additional hardware (such as a redundant memory with the OS installed) in an effort to reduce costs. Additionally, since a HLOS may be updated and changed after the original manufacture, the expected result of the integrity check may not be static. As a result, the HLOS integrity validation process should not depend on comparing a measurement result to a factory installed local static variable.

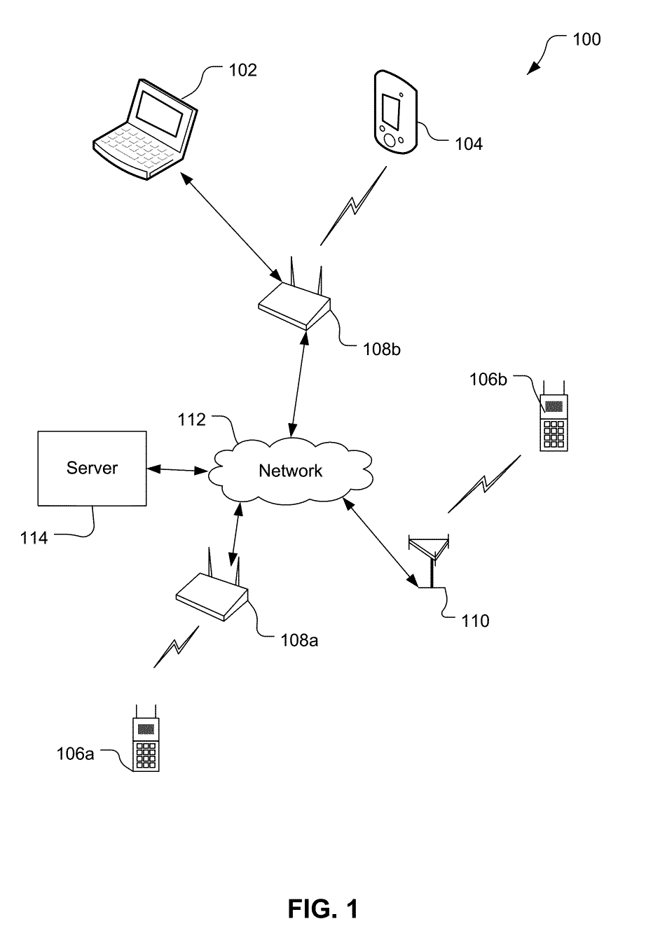

Referring to FIG. 1, a functional block diagram of an example networked computer system 100 in which HLOS validation techniques may be implemented is shown. The networked computer system 100 includes multiple data processing devices such as a personal computer 102, a tablet computer 104, and smartphones 106a, 106b. The data processing devices may be any suitable electronic device (e.g., a notebook computer, a tablet computer, a netbook, a mobile phone, a gaming console, a personal digital assistant (PDA), inventory tag, etc . . . ). The networked computer system may also include one or more access points 108a, 108b, and/or base stations 110 configured to communicate with data processing devices and to enable connection with one or more networks 112. For example, the network 112 may be a Wide Area Network (WAN) and/or a Wireless Local Area Network (WLAN) and may further include a connection to the Internet. The access points 108a, 108b (collectively referred to as 108) may be an advanced WLAN access points capable of determining their own positions (e.g., a self-locating access point). The base station 110 may include an electronic switching function and may be configured as a Media Gateway (MGW) or Gateway Media Switching Center Server (GMSC).

The network 112 may provide connection to one or more servers 114. The server 114 is a data processing device including a processor and a memory, and is configured to execute computer executable instructions. For example, a server 114 may comprise a computer system including a processor, non-transitory memory, disk drives, a display, a keyboard, a mouse. The processor is preferably an intelligent device, e.g., a personal computer central processing unit (CPU) such as those made by Intel® Corporation or AMD®, a microcontroller, an application specific integrated circuit (ASIC), etc. The memory includes random access memory (RAM) and read-only memory (ROM). The disk drives include a hard-disk drive, a CD-ROM drive, and/or a zip drive, and may include other forms of drives. The display is a liquid-crystal display (LCD) (e.g., a thin-film transistor (TFT) display), although other forms of displays are acceptable, e.g., a cathode-ray tube (CRT). The keyboard and mouse provide data input mechanisms for a user. The server 114 may store (e.g., in the memory) processor-readable, processor-executable software code containing instructions for controlling the processor to perform functions described herein. The functions assist in the dynamic integrity validation of a HLOS on one or data processing devices. The functions may include, for example, generating cryptographic functions, digital signature algorithms, data collection, data cluster identification, and data dissemination. The software can be loaded onto the memory by being downloaded via a network connection, uploaded from a disk, etc. Further, the software may not be directly executable, e.g., requiring compiling before execution. Other data processing devices (e.g., 102, 104, 106) are configured to communicate with the server 114 to send and/or receive HLOS validation information. The server 114 may include a data structure (e.g., relational database, flat files) to store HLOS validation information. For example, the server 114 may include a database of cryptographic results (e.g., signed hashes) related to HLOS partitions on one or more data processing devices. The configuration of the server 114 is exemplary only, and not a limitation. In an embodiment, the server 114 may be connected directly to an access point or a base station. More than one server may be used. The server 114 may include one or more databases containing HLOS validation information associated with other data processing devices on additional networks. In an example, the server 114 is comprised of multiple server units.

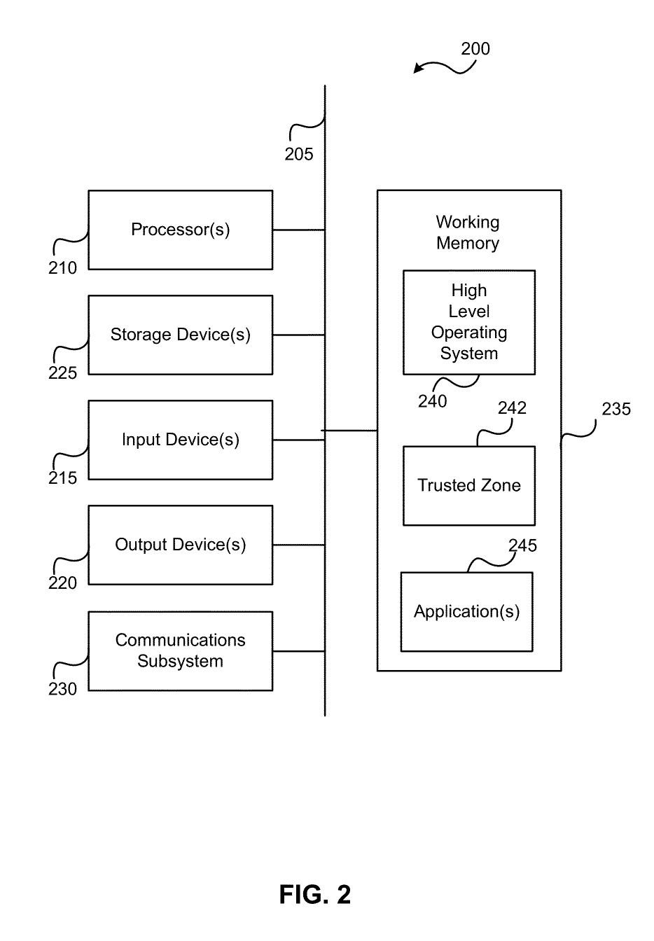

Referring to FIG. 2, a functional block diagram of the example computer system 200 utilizing a HLOS is shown. The computer system 200 as illustrated in FIG. 2 may incorporate as part of the previously described data processing devices. It should be noted that FIG. 2 is meant only to provide a generalized illustration of various components with an apparatus, any or all of which may be utilized as appropriate. FIG. 2, therefore, broadly illustrates how individual system elements may be implemented in a relatively separated or relatively more integrated manner.

The computer system 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like). The processors 210 may include a Trusted Execution Environment (TEE) such as the ARM TrustZone® technology which may be integrated into the processors 210. The computer system 200 may also include one or more input devices 215, which can include without limitation a mouse, a keyboard and/or the like; and one or more output devices 220, which can include without limitation a display device, a printer and/or the like.

The computer system 200 may further include (and/or be in communication with) one or more storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 200 might also include a communications subsystem 230, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 230 may permit data to be exchanged with a network (such as the network 112 described above, to name one example), other computer systems, and/or any other devices described herein. In many embodiments, the computer system 200 will further comprise a working memory 235, which can include a RAM or ROM device.

The computer system 200 also may comprise hardware and software elements, shown as being currently located within the working memory 235, including an stored High Level Operating System (HLOS) 240, a trusted zone 242, device drivers, executable libraries, and/or other code, such as one or more application programs 245, which may comprise computer programs provided by various embodiments, and/or may be designed to implement methods, and/or configure systems, provided by other embodiments, as described herein. The working memory 235 may be divided into multiple partitions such that functions and/or applications may persist within one or more of the partitions. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code may be stored on a computer-readable storage medium, such as the storage device(s) 225, or in the working memory 235. In some cases, the storage medium might be incorporated within a computer system, such as the computer system 200. For example, the working memory may include an Embedded Multi-Media Card (eMMC). The trusted zone 242 may work in conjunction with a secure environment such as the ARM TrustZone® technology. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

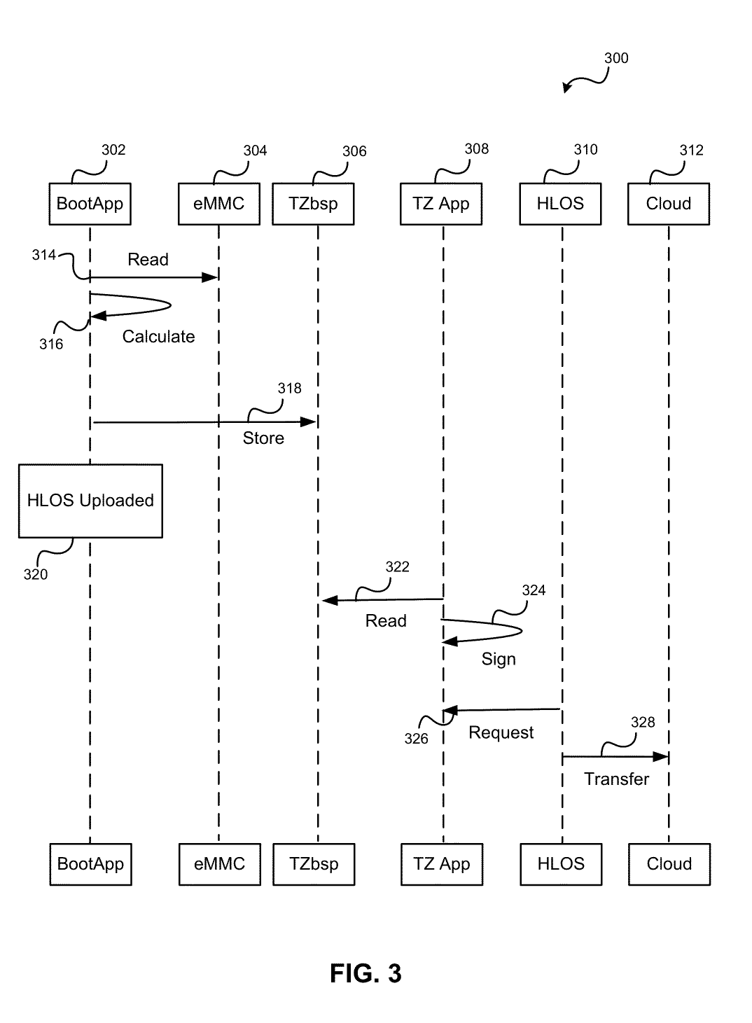

Referring to FIG. 3, with further reference to FIGS. 1 and 2, an exemplary sequence diagram of a HLOS validation process 300 is shown. The operation sequence utilizes the hardware and software components of the computer system 200. The sequence diagram includes a Boot Application (BootApp) 302, an eMMC 304, a Trusted Zone Board Support Package (TZbsp) 308, a Trusted Zone Application (TZ App) 308, an executing High Level Operating System (HLOS) 310, and a remote computing capability generically referred to as the Cloud 312. The processors 210 may include a register to store boot source information such as memory addresses for one or more partitions including boot instructions. The memory addresses may indicate locations in the eMMC 304 (i.e., the working memory 235) and the processors 210 are configured to receive and execute the corresponding boot instructions stored at those locations. In general, the BootApp 302 may be used to configure memory and load the HLOS. Additionally, the BootApp 302 may be used to for operations such as initializing storage devices 225, input and output devices 215, 220, and communications subsystem 230. The operations in the BootApp 302 are typically performed sequentially. In an embodiment, the BootApp 302 may include read instructions 314 to configure the processor to read a memory partition stored on the eMMC 304. The memory partition may contain instructions that are part of, or utilized by, the HLOS. For example, the partitions may be a kernel (boot) partition, a system partition, and/or a recovery partition. The BootApp 302 may perform a cryptographic function based on the results of the read instructions 314. For example, the BootApp 302 may utilize a Secure Hash Algorithm (e.g., SHA-2 set: SHA-224, SHA-256, SHA-384, SHA-512, SHA-512/224, SHA-512/256) to calculate a hash 316 corresponding to one or more partitions. Other cryptographic functions may also be used. The BootApp 302 is then configured to store the calculated hash in a trusted memory location during a store sequence 318. The store sequence 318 may include a compare operation configured to compare the current calculated hash with a value of a previously calculated hash stored in the trusted memory (i.e., TZbsp 306). The store sequence may store the current calculated hash only if it is different from the previously stored hash. The TZbsp 306 may contain a collection of hash results representing a history of boot sequences.

The interaction between the BootApp 302 and the trusted memory location occurs prior to loading and executing the HLOS. In an embodiment, the ARM TrustZone® technology may be used. The Trusted Zone may be integrated with one or more processors 210, and a secure state may be extended throughout the computer system 200 via a secure bus. This approach may enable increased security for peripherals such as secure memory, cryptographic blocks, and selected input and output devices to protect them from malicious code or other forms of software attack. The trusted memory location may be the TZbsp 306. The boot sequence on the data processing device is not interrupted while the hashes are calculated and stored. In an embodiment, the HLOS validation process 300 does not include a state model that is based on the calculated hashes. That is, the hashes are determined and the boot sequence may continue regardless of the results of the hashes. At least a portion of the stored HLOS 240 is uploaded from the eMMC 304 (or other memory location) at an HLOS upload sequence 320. Upon completion of the upload, the digital data device may utilize the executing HLOS 310 to perform system functions, such as controlling peripheral devices, executing applications, and accessing/writing to memory locations.

During a hash read segment 322, the executing HLOS 310 may load and execute a TrustZone technology application (e.g., TZ App 308) to read the calculated hashes stored in the TZbsp 306. The TZ App 308 may also execute a cryptographic signature protocol on the stored hashes in a private key signing sequence 324. The cryptographic signature protocol may be based on public-key signature algorithm, such as RSA-PSS (Rivest, Shamir and Adleman—Probabilistic Signature Scheme). The signed hash results may be stored in the working memory 235, and may be accessed by the executing HLOS 310 at a future time. In an example, the executing HLOS 310 may execute a signed hash request sequence 326 to request the signed hash results from the TZ App 308. Thus, even if the executing HLOS 310 has been tampered with, the corrupted HLOS cannot change the TZ signature on the hash results (e.g., the private key signing sequence occurs within the TZ App 308). Also, the executing HLOS 310 cannot impact the calculated hashes because the BootApp 302 process is secured (i.e., cannot be changed), and the hashes are calculated and stored in the TZbsp 306 before the stored HLOS 240 is loaded.

The executing HLOS 310 may execute a transfer signed hash results sequence 328 to transfer the signed hash results to the cloud 312. The cloud 312 generally represents a trusted web server including network, servers, and associated hardware configured to receive, store, and process the signed hash results. For example, the network 112 and the server 114 in FIG. 1 may be the cloud 312. The cloud 312 may verify the integrity of the hash calculation of the stored HLOS 240 and compare it to a database of expected results to make a determination on whether or not the stored HLOS 240 has been tampered with or not. In this manner, the HLOS may be updated on the device, and if the cloud database is updated with the expected hashes, the cloud will validate the results on the device. The cloud 312 may provide a conformation message to the device to indicate the status of the validation. The cloud 312 may initiate a request to the device for the signed hash results. A corrupted executing HLOS may deny the transfer to the cloud 312, but in such a case, the cloud 312 may determine that the HLOS has been tampered with. In an example, the cloud 312 may initiate a communication with a user associated with the device to inform them that the HLOS (e.g., stored and/or executing) on their device may be corrupted. The communication may be through an independent medium such as a telephone, fax, email, or postal service.

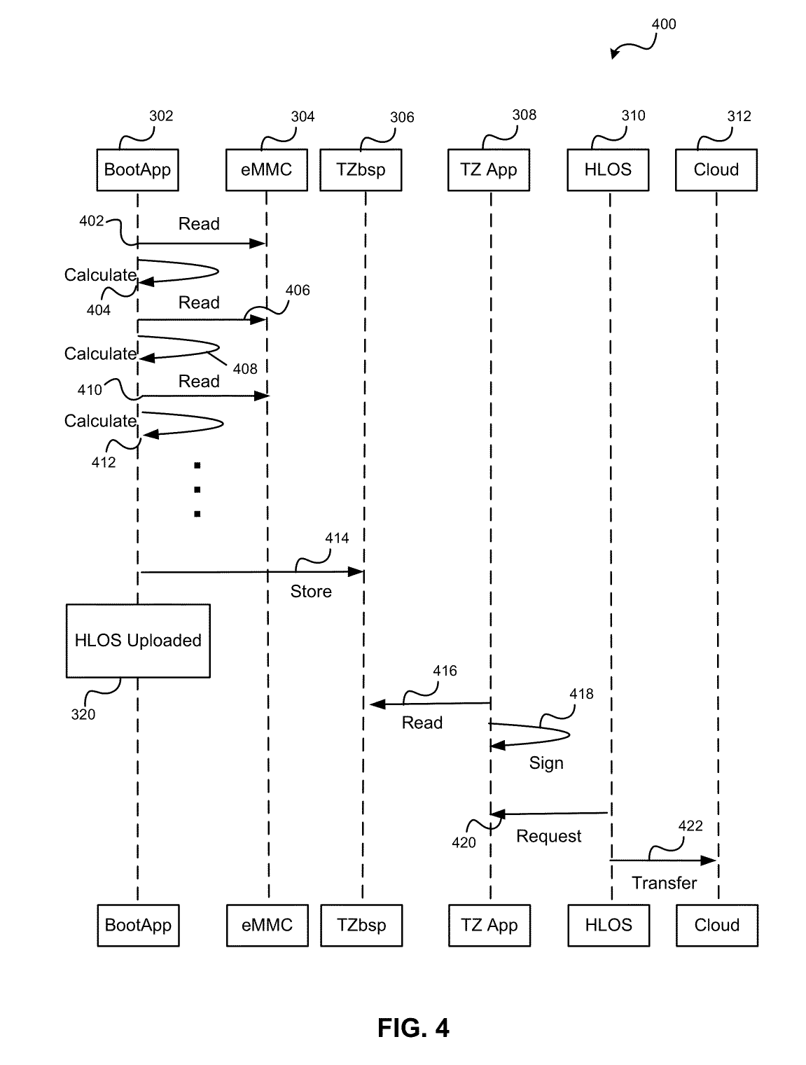

Referring to FIG. 4, with further reference to FIGS. 1-3, an exemplary sequence diagram of a HLOS validation process 400 including multiple cryptographic functions for HLOS partitions is shown. As previously described, the operation sequence utilizes the hardware and software components of the computer system 200. The sequence diagram includes a BootApp 302, an eMMC 304, a TZbsp 306, a TZ App 308, an executing HLOS 310, and the cloud 312. In the HLOS validation process 400, the BootApp 302 is configured to perform multiple read can hash calculation sequences on multiple partitions in the eMMC 304. As an example, and not a limitation, the BootApp 302 may perform a read kernel partition sequence 402 and a calculate kernel partition hash sequence 404, a read system partition sequence 406 and a calculate system partition hash sequence 408, a read recovery partition sequence 410 and a calculate recovery partition hash sequence 412. Reading and hash calculation sequences may be performed on other partitions associated with the stored HLOS 240. The BootApp may then perform a store hash results sequence 414 to store the respective hash results into a trusted memory location (e.g., the TZbsp 306). The hash results may be stored independently, or in another form such as a concatenated string, an array, or other data form. The store hash results sequence 414 may include a compare operation such that only changed hash values are stored. The HLOS upload sequence 320 is performed after the hash results are stored in the trusted memory.

The stored HLOS 240 may load and instruct the TZ App 308 to perform a multiple hash read sequence 416 and a corresponding multiple hash signing sequence 418. These sequences may include reading and signing the multiple stored hashes individually (i.e., each hash result is signed with a private key). The multiple hash read sequence 416 and the multiple hash signing sequence 418 may sign the hash results collectively (i.e., the collective results are signed with a private key). Other combinations may also be used. Similarly, the executing HLOS 310 may execute a signed hash request sequence 420 and a signed hash transfer sequence 422 to request and transfer the respective signed hashes individually, collectively, or in other combinations. The multiple hashes may be stored on the cloud 312 based on the respective partition. A cloud database may cluster the hash results for each partition and determine whether a specific partition (e.g., kernel, system, recovery, etc . . . ) has been tampered with.

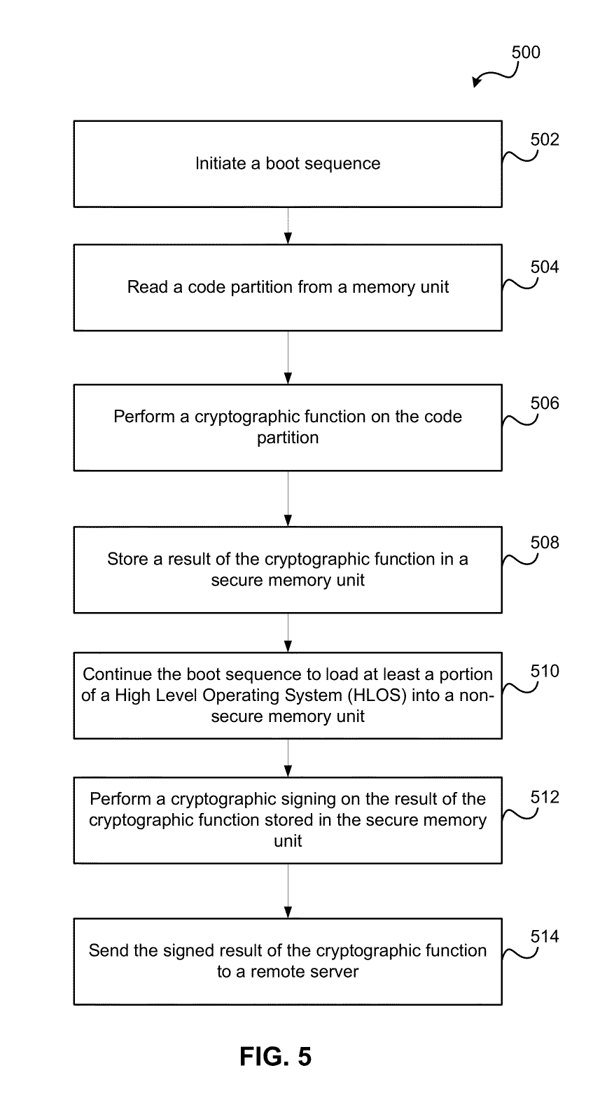

Referring to FIG. 5, with further reference to FIGS. 1-4, a process 500 for providing HLOS validation information to a remote server includes the stages shown. The process 500 is, however, an example only and not limiting. The process 500 can be altered, e.g., by having stages added, removed, rearranged, combined, performed concurrently and/or having stages split into multiple stages. In an embodiment, the computer system 200 may include processor executable instructions corresponding to the process 500 stored in the working memory 235, and the processor(s) 210 may be configured to execute the instructions.

At stage 502, the processor(s) 210 may be configured to initiate a boot sequence. The boot sequence is typically initiated when a data processing device is powered-up or reset. The instructions for the boot sequence are included in the basic input/output system (BIOS) included on a Read Only Memory (ROM) chip installed in the data processing device. The BIOS may be included on the processor(s) 210, or in the working memory 235. The BIOS includes the code required to control functions such as the keyboard, display screen, communications, and other functions such as access to memory locations. The boot sequence is performed prior to the loading of the stored HLOS 240.

At stage 504, the processor(s) 210 are configured to read a code partition from a memory unit. The memory unit may be part of the working memory 235. In an example, the working memory includes an eMMC and the boot sequence includes instructions to read partitions associated with the stored HLOS 240 that are stored in the eMMC. The boot sequence may read one or more partitions such as a kernel partition, a system partition, and/or a recovery partition. Reading a code partition does not necessarily require loading and executing the corresponding code. The reading is sufficient to enable the processor(s) 210 to perform one or more cryptographic functions on one or more code partitions without executing the code contained in the partition.

At stage 506, the processor(s) 210 are configured to perform a cryptographic function on the code partition. The code partition may be considered a message input to cryptographic functions (e.g., hashes) and the processor(s) 210 are configured to compute the corresponding digest from the input message. The cryptographic function may be an established function (e.g., MD5, SHA-1, SHA-2, SHA-256, etc . . . ), or another custom solution. In general, the cryptographic function should be computationally efficient and collision resistant. In an embodiment, the input message to the cryptographic function may include multiple partitions stored on the eMMC and/or in other areas of the working memory 235. At stage 508, the processor(s) 210 are configured to store the result of the cryptographic function in a secure memory unit. For example, the digest of a cryptographic function may be stored in the trusted zone 242. The ARM TrustZone® technology may be used such that the processor(s) 210 and trusted zone 242 are integrated to create a secure state (i.e., a secure operating mode). In an embodiment, the result of the cryptographic function may include multiple digests associated with multiple messages (i.e., multiple partitions). For example, separate digests for the kernel, system, and recovery partitions may be calculated. Other digests for other partitions that are part of the stored HLOS 240 may also be calculated and stored.

At stage 510, the processor(s) 210 are configured to continue through the boot sequence and load at least a portion of the stored HLOS 240 in a non-secure memory unit. A non-secure memory unit may be a memory location that is outside of the trusted zone 242 and generally accessible by the executing HLOS 310 and other applications. The stored HLOS 240 may include several partitions in the eMMC, or other memory locations, and not every partition must be loaded into the working memory 235 to enable functions on the device. The stored HLOS 240 may be loaded regardless of the results of the cryptographic function determined at stage 506. That is, the execution of the boot sequence need not be conditionally dependent on a verification of the hash values associated with the HLOS partitions. Once at least some of the stored HLOS 240 is loaded into working memory, the processor(s) 210 may execute the associated operating system functions and execute code associated with other application programs 245. For example, the device may execute trust zone applications including additional cryptographic functions such as creating digital signatures.

At stage 512, the processor(s) 210 are configured to perform a cryptographic signing on the result of the cryptographic function stored in the secure memory unit. The cryptographic signing may utilize at least a portion of the executing HLOS 310 to request a digital signature. The cryptographic function result (e.g., hash, digest) stored in the trusted zone 242 at stage 508 may be accessed via a trusted execution environment. The ARM TrustZone ® technology, for example, includes a small secure kernel that may be accessed via an Application Interface (API) (i.e., the TZ App 308). The executing HLOS 310 may include instructions to interface with the secure kernel API to request secure data from the trusted zone 242. In an embodiment, the secure kernel may digitally sign the hash results and then provide the signed hash results to the executing HLOS 310. Examples of cryptographic signing (e.g., digital signature algorithms) include RSA and Digital Signature Standard (DSS). The hash results are signed within the trusted environment and thus any subsequent transformation to the signed hash results (e.g., malware operating in the executing HLOS 310) may be detected in a signature verification process (e.g., with the corresponding public key).

At stage 514, the processor(s) 210 are configured to send the encrypted result of the cryptographic function to a remote server (e.g., server 114). The executing HLOS 310 may include instructions to transfer the signed hash received from the TZ App 308 to one or more remote servers in the cloud 312. The signed hash may be provided to the cloud based on a triggering event (e.g., whenever the hash value changes, every boot sequence, the first boot sequence of the day, when signing on to a network, when connected to a power source, etc . . . ), or on a periodic basis (e.g., daily, weekly, monthly). The data processing device may initiate the transfer, or may respond a request from a remote server. The signed hash results may be stored and validated on the server 114. For example, the validation process may include comparing the transmitted hash values with results stored on the remote server. The stored results may be based on the initial configuration for the device, or may be dynamically derived based on clustering the hash results received from a collection of devices.

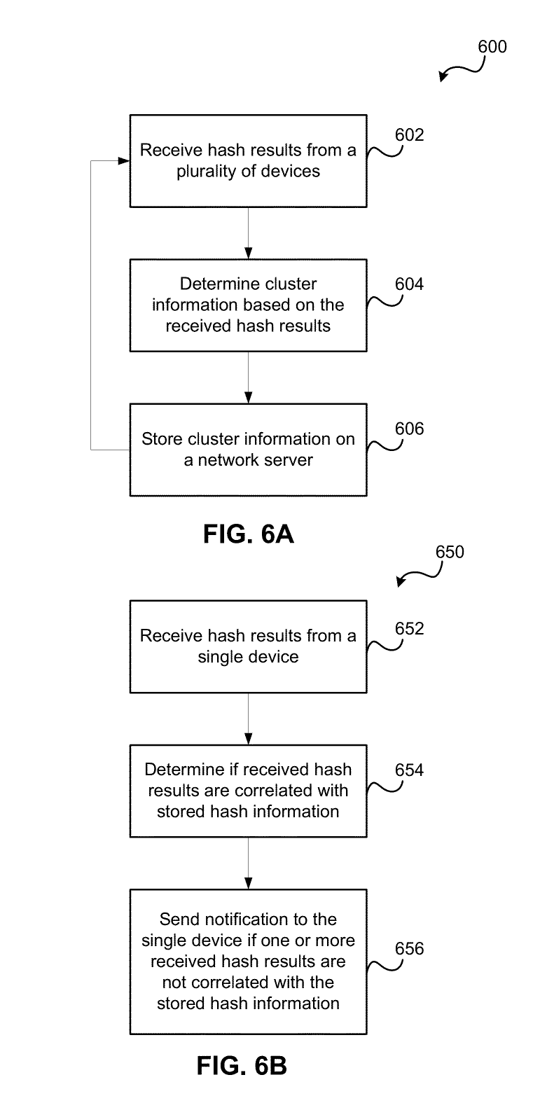

Referring to FIG. 6A, with further reference to FIGS. 1-5, a process 600 for determining HLOS validation information clusters includes the stages shown. The process 600 is, however, an example only and not limiting. The process 600 can be altered, e.g., by having stages added, removed, rearranged, combined, performed concurrently and/or having stages split into multiple stages. In an embodiment, the server 114 is a computer system 200 and may include processor executable instructions corresponding to the process 600 stored in the working memory 235, and the processor(s) 210 may be configured to execute the instructions. The server 114 may be part of an access point 108a, 108b or a base station 110. A network may have more than one server 114.

At stage 602, the server 114 is configured to receive hash results from a plurality of devices (e.g., a plurality of data processing devices). The hash results are cryptographic functions associated with one or more partition of a HLOS installed on the devices. The hash results may be signed with a private key (e.g., RSA, DSS) and the server 114 may validate the results with the corresponding public key. The server 114 may be comprised of multiple servers across the network 112, and the hash results from multiple data processing devices may be stored on the server 114. The server 114 may include a data structure such as a relational database, or a flat file configuration (e.g., XML), to store the hash results and may be configured to index the received hash results based on a device ID, or other identifying information associated with a device. The data structure may include a collection of fields for each device to store and index the collection of hash results (e.g., date, device type, partition type (e.g., boot image, system image, recovery image), operating system, version number, etc . . . ). The data structure and corresponding indexing are organized to enable vectors for use in clustering the received hash results.

At stage 604, the server 114 is configured to determine cluster information based on the received results (e.g., the received hashes). The cluster information represents variations of the hash values that are within a predefined range. The HLOS stored on each device may have variations in measurement date (e.g., partition messages) based on, for example, device type, hardware configuration, HLOS partition, and HLOS version. The hash results may include vectors associated with the variations, and the clustering algorithms executing on the server may determine distances (e.g., Euclidean and Non-Euclidean) between the vectors. The clustering algorithm may be based on the Bradley-Fayyad-Reina (BFR) algorithm. In general, the BFR algorithm is designed to process very large data sets such as a collection of hash values across one or more networks. The results of the clustering algorithm may be stored on the server 114 at stage 606. The cluster information stored on the network server may be used to validate subsequently received hash results from a data processing device. A distance between the hash results vectors and the established clusters may be determined, and a validation determination may be based on the distance result. For example, if the received hash results are at near or within the clusters, the HLOS is likely to be valid, and conversely, if the distance between the received hash results and the clusters is large (or above an established threshold), the HLOS is likely to be invalid (i.e., tampered with). In this manner, validating integrity of an HLOS on a data processing device based on a distance value may be realized.

Referring to FIG. 6B, with further reference to FIGS. 1-6A, a process 650 for dynamically verifying HLOS validation information includes the stages shown. The process 650 is, however, an example only and not limiting. The process 650 can be altered, e.g., by having stages added, removed, rearranged, combined, performed concurrently and/or having stages split into multiple stages. In an embodiment, the server 114 is a computer system 200 and may include processor executable instructions corresponding to the process 650 stored in the working memory 235, and the processor(s) 210 may be configured to execute the instructions. The server 114 may be part of an access point 108a, 108b or a base station 110. A network may have more than one local or remote servers.

At stage 652, the server 114 is configured to receive hash results from a single data processing device. The hash results may be provided based on a trigger event, or on a periodic cycle. For example, a data processing device may calculate a hash result for an HLOS partition during each boot sequence, and send the hash results to the server 114 if a currently calculated hash for the HLOS partition is different from previous hash results. At stage 654, the server 114 is configured to determine if the received hash results are correlated with stored hash information. The stored hash information may be cluster information calculated in the process 600 above. The stored hash information may be the hash values previously received from the device, or previously stored by the device manufacturer. For example, a device manufacture may store hash information of the server 114 based on a device type and operating system version and the received hash results can be compared against the manufacturers stored hash information. In this way, a manufacturer may update the hash results when new or updated versions of a HLOS are distributed (e.g., pushed) to users. The received hash results may be correlated with the stored hash information if they are same, or within a specified distance on one another (i.e., the integrity of the HLOS may be validated based on the distance). A received hash result is correlated if it is, for example, within or near a calculated cluster or preset value (i.e., a threshold).

At stage 656, the server 114 is configure to send a notification message to the single device if one or more received hash results are not correlated with the stored hash results. The notification message may be in the form of an email or text message to an account that is associated with single device. Since the uncorrelated results may indicate that the HLOS has been compromised, an independent notification process may be used (i.e., a process that is not dependent on the device). An automated telephone call may be generated by the server 114. The notification message may be sent directly to the device, and may include instructions to correct the corrupted system. In an example, the received hash results may be correlated with cluster associated with a particular piece of malware. The notification message may include a code segment to be loaded onto the device as a remedy to the specific malware. The notification message, and the corresponding code segment, may disable one or more processes executing on the device in an effort to reduce the impact of the malware. The notification message may be configured to limit the functionality of the device to reduce the impact of the corrupted HLOS on the user and/or the network.

As mentioned above, in one aspect, some embodiments may employ one or more computer systems (such as the computer system 200) to perform methods in accordance with various embodiments of the invention. According to a set of embodiments, some or all of the procedures of such methods are performed by the computer system 200 in response to processor(s) 210 executing one or more sequences of one or more instructions (which might be incorporated into the stored HLOS 240 and/or other code, such as in the trusted zone 242 or an application program 245) contained in the working memory 235. Such instructions may be read into the working memory 235 from another computer-readable medium, such as one or more of the storage device(s) 225. Merely by way of example, execution of the sequences of instructions contained in the working memory 235 might cause the processor(s) 210 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 200, various computer-readable media might be involved in providing instructions/code to processor(s) 210 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 225. Volatile media include, without limitation, dynamic memory, such as the working memory 235. Transmission media include, without limitation, coaxial cables, copper wire and fiber optics, including the wires that comprise the bus 205, as well as the various components of the communications subsystem 230 (and/or the media by which the communications subsystem 230 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, eMMC, any other memory chip or cartridge, a carrier wave as described hereinafter, or any other medium from which a computer can read instructions and/or code.

Various forms of computer-readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments of the invention.

The communications subsystem 230 (and/or components thereof) generally will receive the signals, and the bus 205 then might carry the signals (and/or the data, instructions, etc. carried by the signals) to the working memory 235, from which the processor(s) 210 retrieves and executes the instructions. The instructions received by the working memory 235 may optionally be stored on a storage device 225 either before or after execution by the processor(s) 210.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for validating integrity of a High Level Operating System (HLOS) stored on a data processing device, comprising:
initiating a boot sequence on the data processing device;
reading a code partition from a memory unit in the data processing device, wherein the code partition is associated with a HLOS stored in the memory unit;
performing a cryptographic function on the code partition;
storing a result of the cryptographic function in a secure memory unit;
continuing the boot sequence to load at least a portion of the HLOS into a non-secure memory unit;
performing a cryptographic signing on the result of the cryptographic function stored in the secure memory unit; and
sending a signed result of the cryptographic function to a remote server.

2. The method of claim 1 wherein the code partition is selected from a group consisting of a kernel partition, a system partition, and a recovery partition.

3. The method of claim 1 wherein the result of the cryptographic function is a hash based on the code partition.

4. The method of claim 3 wherein performing the cryptographic signing on the result of the cryptographic function includes executing a private key signing sequence of the hash.

5. The method of claim 1 further comprising receiving a notification message from the remote server.

6. The method of claim 5 wherein the notification message includes a code segment configured to disable a process executing on the data processing device.

7. The method of claim 4 further comprising:
receiving a plurality of hashes from a plurality of data processing devices;
determining a data cluster information based on the plurality of hashes; and
storing the data cluster information on the remote server.

8. The method of claim 7 further comprising:
receiving a first hash from a first data processing device;
determining a distance value between the first hash and the data cluster information; and
validating integrity of the HLOS on the first data processing device based on the distance value.

9. A non-transitory processor-readable storage medium comprising instructions for validating integrity of a High Level Operating System (HLOS) stored on a data processing device, the instructions comprising:
code for initiating a boot sequence on the data processing device;
code for reading a code partition from a memory unit in the data processing device, wherein the code partition is associated with a HLOS stored in the memory unit;
code for performing a cryptographic function on the code partition;
code for storing a result of the cryptographic function in a secure memory unit;
code for continuing the boot sequence to load at least a portion of the HLOS into a non-secure memory unit;
code for performing a cryptographic signing on the result of the cryptographic function stored in the secure memory unit; and
code for sending a signed result of the cryptographic function to a remote server.

10. The non-transitory processor-readable storage medium of claim 9 wherein the code partition is selected from a group consisting of a kernel partition, a system partition, and a recovery partition.

11. The non-transitory processor-readable storage medium of claim 9 further comprising code for generating a hash based on the code partition as the result of the cryptographic function.

12. The non-transitory processor-readable storage medium of claim 11 further comprising code for executing a private key signing sequence of the hash.

13. The non-transitory processor-readable storage medium of claim 9 further comprising code for receiving a notification message from the remote server.

14. The non-transitory processor-readable storage medium of claim 13 further comprising code for disabling a process executing on the data processing device.

15. The non-transitory processor-readable storage medium of claim 12 further comprising:
code for receiving a plurality of hashes from a plurality of data processing devices;
code for determining data cluster information based on the plurality of hashes; and
code for storing the data cluster information on the remote server.

16. The non-transitory processor-readable storage medium of claim 15 further comprising:
code for receiving a first hash from a first data processing device;
code for determining a distance value between the first hash and the data cluster information; and
code for validating integrity of the HLOS on the first data processing device based on the distance value.

17. An apparatus, comprising:
a first memory unit for storing instructions; and
a first processor unit coupled to the first memory unit and configured to:
initiate a boot sequence on the apparatus;
read a code partition from the first memory unit in the apparatus, wherein the code partition is associated with a HLOS stored in the first memory unit;
perform a cryptographic function on the code partition;
store a result of the cryptographic function in a secure memory unit;
continue the boot sequence to load at least a portion of the HLOS into the first memory unit;
sign the result of the cryptographic function stored in the secure memory unit; and
send a signed result of the cryptographic function to a remote server.

18. The apparatus of claim 17 wherein the result of the cryptographic function is a hash based on the code partition.

19. The apparatus of claim 18 further comprising:
a second memory unit for storing instructions; and
a second processor unit coupled to the second memory unit and configured to:
receive a plurality of hashes from a plurality of data processing devices;
determine a data cluster information based on the plurality of hashes; and
store the data cluster information.

20. The apparatus of claim 19 wherein the second processor unit is further configured to:
receive a first hash from a first data processing device;
determine a distance value between the first hash and the data cluster information; and
validate integrity of the HLOS on the first data processing device based on the distance value.
